(19) United States
(12) Patent Application Publication
(10) Pub. No.: US 2009/0305209 A1
(43) Pub. Date: Dec. 10, 2009

(54) Online protocol/tool for evaluating acne lesions

(75) Inventors: Michael Graeber, Lawrenceville, NJ (US); Ming Lu, Plainsboro, NJ (US); Judi Gidner, Yardley, PA (US)

Correspondence Address: BUCHANAN, INGERSOLL & ROONEY PC, POST OFFICE BOX 1404, ALEXANDRIA, VA, 22313-1404, US

(73) Assignee: GALDERMA RESEARCH & DEVELOPMENT, Biot (FR)

(21) Appl. No.: 12/314,353

(22) Filed: Dec. 9, 2008

Related U.S. Application Data
(63) Continuation of application No. PCT/EP2007/055675, filed on Jun. 8, 2007.
(60) Provisional application No. 60/812,883, filed on Jun. 9, 2006.

(51) Int. Cl. G09B 23/28

(52) U.S. Cl. 434/262

(57) ABSTRACT

A web-based protocol/tool to improve the identification and characterization process of evaluators in recognizing and distinguishing acne lesions, included at least the following program activities:
a protocol for a global assessment of acne lesions;
a protocol for a lesion counting training;
a protocol for a model counting practice.

### CROSS-REFERENCE TO PRIORITY/PCT/PROVISIONAL APPLICATIONS

This application is a continuation of PCT/EP 2007/055675 filed Jun. 8, 2007 and designating the United States, published in the English language as WO 2007/141340 A1, on Dec. 13, 2007, and claiming benefit under 35 U.S.C. 119(e) of Provisional Application No. 60/812,883, filed Jun. 9, 2006, each hereby expressly incorporated by reference in its entirety and each assigned to the assignee hereof.

### BACKGROUND OF THE INVENTION

1. Technical Field of the Invention

The present invention relates to a web-based online protocol/tool to evaluate acne lesions. Such online protocol/tool comprises program activities and a method for training dermatologists and study staff to identify and distinguish acne lesions. More particularly, the present invention relates to an online method of educating dermatologists and study staff to recognize and categorize specific types of acne lesions in an effort to improve the results of clinical trials.

2. Description of Background and/or Related and/or Prior Art

Dermatology is the medical discipline focused on the diagnosis and treatment of skin disorders. Acne vulgaris (hereafter acne) is the relevant skin disorder for the purpose of this application. Novel treatments and control treatments, including vehicles or placebos, are evaluated in clinical trials (generally multi-center trials) conducted in subjects with acne.

To perform a multi-center clinical trial evaluating acne medications, a high number of study sites from around the world must be recruited, and evaluators trained to perform the trial assessments consistently, i.e., with acceptable variability, must be available.

The use of a specific drug or method of treatment is based on prior knowledge of whether a drug or treatment is effective for a particular ailment, symptom, disease, etc. Such prior knowledge is typically obtained through the utilization of clinical trials of the drug or treatment for particular diseases, ailments or symptoms to ascertain whether that drug, for example, yields satisfactory results in the treatment of the particular ailment. The terms “disease”, “ailment”, “symptom” and “illness” are used interchangeably herein. Wider application of the drug to other diseases is not easy to achieve without further individual clinical trials associated with each specific disease. Therefore, considerable time, effort and expense are required to determine whether a drug will be effective in treating particular diseases. Moreover, once efficacy of a drug for a particular disease has been identified, additional clinical trials must be conducted to ascertain whether that drug will also be effective on variations or categories of the identified disease.

In the United States (U.S.), efficacy data of a drug for the treatment of an ailment or disease obtained from clinical trials are submitted to the Food and Drug Administration (FDA) for the purpose of obtaining approval from the FDA to market the drug for the treatment of the ailment or disease. Because of the expense and time in conducting clinical trials, it is desirable for the clinical trial data to show that the tested drug has been effective on a particular treated disease as well as on variations of the particular disease (and the probability of effectiveness) so that FDA approval of the drug for such variations can be obtained based on the same set or similar sets of clinical trial data. For this reason, and in the case where variations of a disease are known, it is beneficial for clinicians, during the screening process used in identifying potential patients for a clinical study of a drug, to be able to identify and distinguish from patients with the disease and patients with variations of the disease. Once that identification has occurred, the clinicians can then obtain data from the treatment of those patients in order to recognize which variations of the disease have been successfully treated by the drug.

For example, and in the case of skin ailments or skin diseases, different types of skin lesions may appear. Some lesions may be treatable by topical application of a drug, e.g., a cream or ointment, etc., while that same drug may be ineffective against other types of lesions. Clearly, therefore, a basic step of a clinical trial for determining whether a drug is effective against certain types of lesions is for the clinicians to be able to identify and categorize, on a consistent basis, types of lesion such that patient eligibility for a clinical study can be ascertained.

Need therefore exists to provide an interactive, accessible and convenient tool for dermatologists or study staff to provide them information, help and training to improve expertise to identify and categorize acne lesions. However there is no existing method and tools to train evaluators (dermatologists, clinicians . . . ) particularly in clinical trials in evaluating new treatments in acne vulgaris. It is significantly convenient to provide such a tool in case of “multi-center” clinical trials where evaluators are deployed in several countries worldwide.

In addition, it has been observed that acne lesion evaluations vary among evaluators in the following areas: lesion severity, classification (i.e., inflammatory, non-inflammatory . . . ) and counts; therefore, inducing a large variability in pathology assessments. This includes patient eligibility in accordance with study specific entry criteria and subsequent treatment evaluations.

### SUMMARY OF THE INVENTION

The present invention manages these insufficiencies by providing a set of web-based accessible tools comprising a comprehensive training and testing program.

The present invention thus features a web-based protocol/tool to improve the identification and characterization process of evaluators in recognizing and distinguishing acne lesions in a more standardized manner. Such protocol/tool is interactive and divided into several program activities to train and test evaluators in identifying and categorizing acne lesions. The subject program activities are directed by software which renders it interactive and encompasses model images approved by a group of experts.

In the case of clinical trials of a drug for acne where lesions are assessed, it is necessary to ensure that lesions are classified in a standardized manner. For example, different classifying evaluators who are assessing patients for a clinical study should classify lesions on a more consistent basis. The present invention standardizes the way lesion types are categorized to facilitate identification by evaluators. The present invention assists prospective lesion evaluators in improving their skills at identifying and classifying lesion types. A uniform classification of lesions is enhanced by implementing training to ensure the evaluators utilize a systematic approach to classify/identify lesions.

### BRIEF DESCRIPTION OF THE DRAWINGS

FIGS. 1-11 of the drawings are photographs of models variously showing the types, severity, counting and assessment of various lesions, whether acne vulgaris and/or inflammatory/non-inflammatory skin lesions.

### DETAILED DESCRIPTION OF BEST MODE AND SPECIFIC/PREFERRED EMBODIMENTS OF THE INVENTION

The web-based tool according to the present invention comprises at least the following program/protocol activities:

a global assessment of acne lesions;

a lesion counting training;

a model counting practice.

In particular, the global assessment activity encompasses at least:

a learning session comprised of several cases of acne model photos with lesions and related assessment ratings

a testing session comprising cases showing 3 picture views of each model with at least up to 60 model cases and preferably from 20 to 40 model cases.

In a preferred embodiment, each testing session is comprised of 20 cases with 3 picture views per case.

Similarly, the lesion counting training comprises several sets of counting exercises and in particular at least 3 sets of exercises. The present invention encompasses also the use of the web-base tools described above for identifying, categorizing and counting acne lesions.

The present invention thus features a method for identifying, categorizing and counting acne lesions, said method comprising the following steps:

acquiring model images to be assessed and approved by a group of dermatology experts;

providing a “bank” or database of approved images and related expert consensus ratings;

utilizing the database to train users to identify lesions; employing the database to allow users to practice identifying and counting lesions when patients are subsequently examined, whether in a clinical trial, teaching, medical practice or other clinical applications; and/or

using the populated database to train users to identify lesions when patients are subsequently examined to improve the identification and characterization process of dermatologists and study staff in recognizing and distinguishing acne lesions among different types of known variations of a disease so that the identification can be performed in a more standardized basis.

Each step of the said methods can be performed with a computer-based or web-based online application and preferably the web-based online protocol/tool as described above.

In one embodiment, the present invention provides online tools to improve the identification and characterization process of dermatologists and study staff in recognizing and distinguishing acne lesions such that the identification can be performed on a more standardized basis. The present tool is accessible online after entry of a personal user name and a password. This universal web-connection provides a great advantage as it is readily available and convenient for the user.

For example, the setting up of worldwide clinical trials requires clinical centers on several continents. Dermatologists and study staff training is expedited as each dermatologist and/or study staff personnel decides the most appropriate time based upon individual availability.

This tool may shorten or replace “Investigators Meetings” that are dedicated to training.

In a specific embodiment, the tool is divided into three parts with their respective web activities and goals.

Although the term “evaluators” is used herein, it will be readily appreciated that that term can, likewise, include technicians as well as doctors, clinicians and dermatologists who have a need for identifying and distinguishing from different types of acne lesions.

The first part gives a global assessment of acne lesions and is called Investigator Global Assessment (IGA). The purpose of this part of the protocol/tool is first to provide a structured plan to train physicians in identifying and characterizing acne lesions. In addition, the training program is provided to qualify evaluators for clinical studies in acne. The expectation is that this training and approval process will reduce variability and increase inter-rater reliability. The ultimate goal is to provide quality training resulting in well-educated evaluators (investigators) who will evaluate acne with acceptable variability both at entry of subjects into the study and during the subsequent study visits. In turn, the aim is to improve the chances of successful clinical trials in the indication of acne.

To some extent, this first part is used to train and approve individuals as authorized raters (evaluators, dermatologist, clinicians or any trained study personnel) for acne trials.

The IGA using a five point scale (0-4) is assessed via a web-based instrument which offers more flexibility in training as well as an audit trail to track progress across the program. The web-based tool provides an interactive scale for investigators to assess acne severity by rating subject photos.

Before taking the first IGA test, an investigator is offered the opportunity to:

listen to a presentation by an expert, who via archived audio stream supported by synchronized slides introduces the IGA and its scale to be used for this trial. Following the scale an introduction to lesion types is presented including photos that best demonstrate the lesion types, and then several examples of model photos demonstrating each score on the IGA scale;

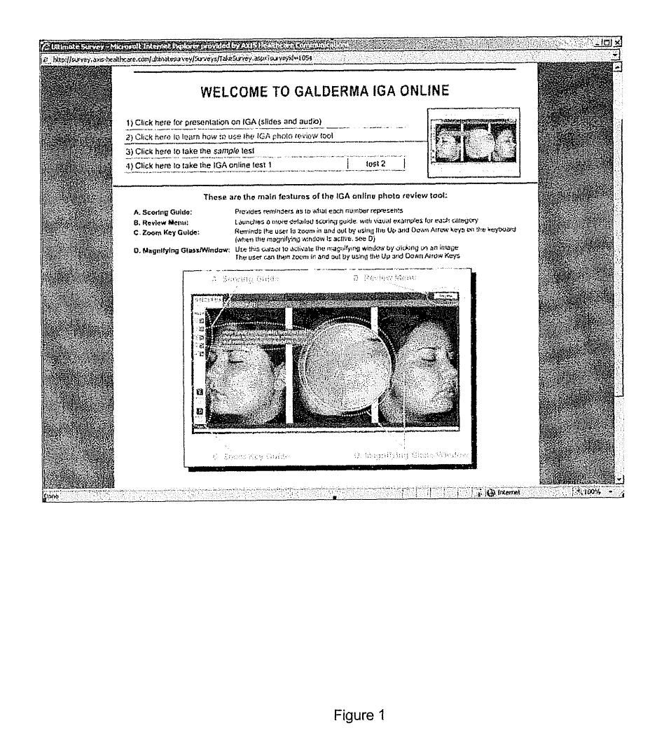

learn how to use the photo review tool. Investigators can see a labeled image of the photo review tool before having to use it. As shown in FIG. 1 and the following, it allows investigators to:

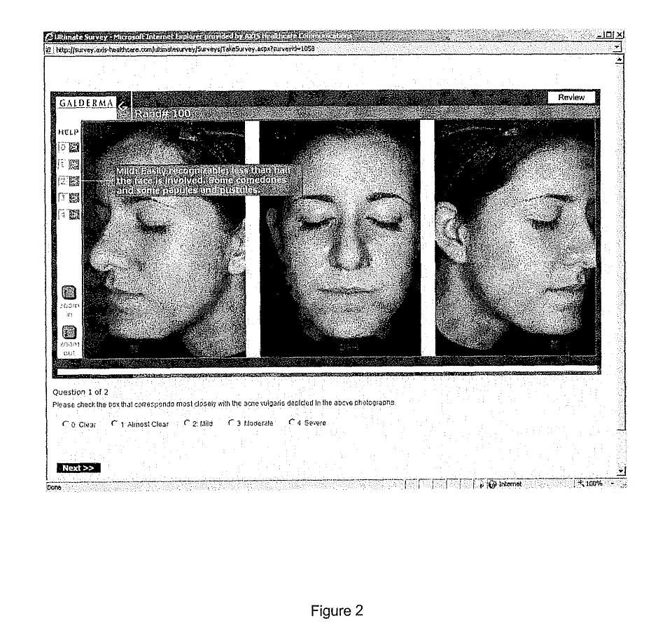

read the description associated with each IGA score as shown in FIG. 2;

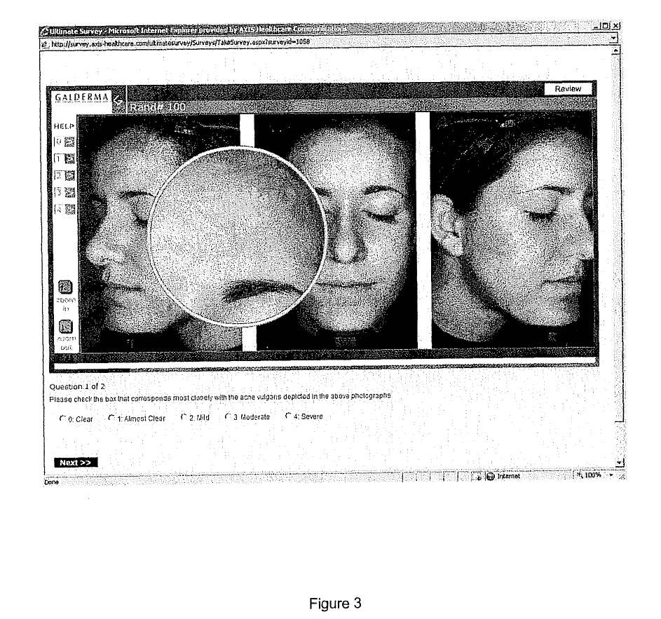

zoom to any point on the model's face as shown in FIG. 3;

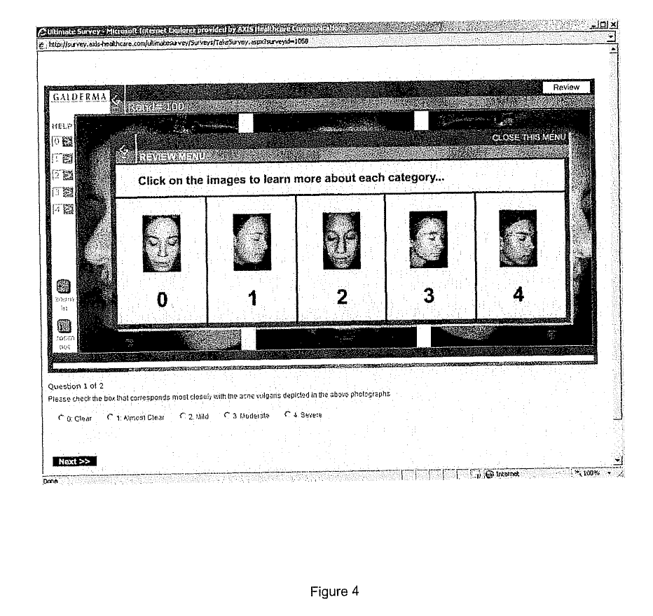

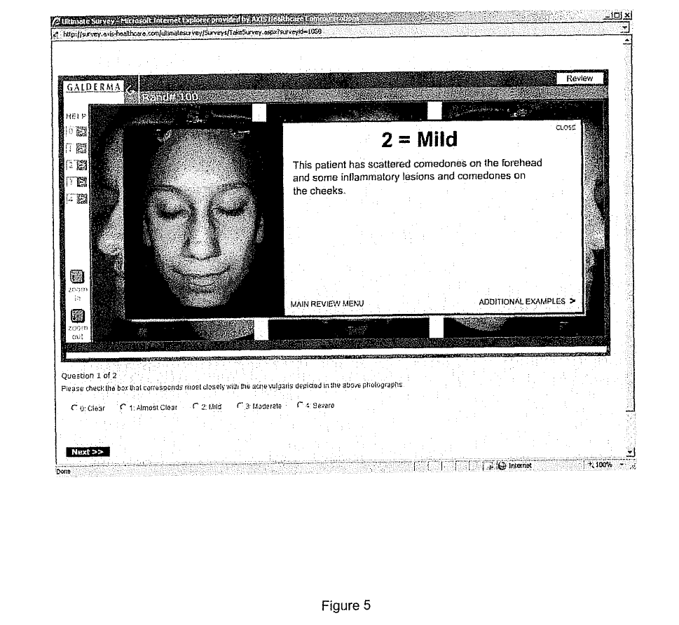

review examples of models spanning the full range of IGA scores as shown in FIGS. 4 and 5;
take a sample test that exactly is the real test experience; access the tests.

Hence, the web-based IGA program aimed to assess and validate each investigator's proficiency in rating clinical trial subjects using the Investigator's Global Assessment Scale.

A 5-point scale ranging from “0” Clear to “4” Severe will be used according to the following table.

TABLE 1
IGA Rating Criteria for Training Purposes:

| | Acceptable Range |
|---|---|
| Scale Attributes | for Each Rating |
| 0 - Clear | 0-1 |
| 1 - Almost Clear | 0-1 |
| 2 - Mild | 2-3 |
| 3 - Moderate (target population for the study) | 2-3 |
| 4 - Severe | 4 |

A testing session will have a total of 20 cases showing 3 picture views of each model (front, left and right cheek). A total of 60 photos will be viewed per session. Colored photos with various severities will be provided.

IGA rater access will be managed via rater-specific password protection. The rater's name, qualifications (Principal Investigator {P.I.}, Medical Doctor {M.D.}./Doctor Osteopathy {D.O.}. Sub-investigator {Sub-I.}), site name (meaning PI name), photo identification and rating for each photo will be recorded.

An e-mail address field on the login page will capture the e-mail addresses of raters who login.

IGA raters may access the web-based training/testing program prior to and after the Investigator Meeting from their own computer. Computers were also made available at the Investigator Meeting.

The web-based training/testing program was available throughout the enrollment period for subsequent training of replacement raters.

The program does not allow any modifications to “locked” ratings. A locked rating is defined as completion and acceptance of the ratings for each session (all 20 cases). The user/rater must agree after each online session that the rating for a given session is complete and this will lock the rating. A prompt will reconfirm a rater is “definitely” ready to lock the ratings and the rater is advised that “NO” further modifications can be made after the session lock is confirmed. Until the point that ratings for all 20 cases are locked, the rater will be allowed to go back and reconsider ratings.

The web-based training/testing program allows only 3 testing sessions to achieve a pass rating.

To pass IGA, a rater must successfully rate 14 out of 20 cases in one testing session. When raters fail to achieve the required rate of correct answers, he/she can decide to retrain before further attempts to pass the test. If a rater passes the first or second attempt, the last screen will read: “Congratulations, you have passed IGA Online Test you will be e-mailed a certificate”.

The close surveillance of “approved” versus “non-approved” raters is expected to increase awareness and reduce overall variability through the availability of online training. In the past, an unapproved rater would not have an opportunity to train outside of the investigator meeting.

For the purpose of the present invention, subject photos are sets (or cases) of 3 pictures views of most representative models of acne pathology with several photos under different angles (for instance front of face, left profile and right profile). In a preferred embodiment, from 20 to 60 sets and most preferred from 20 to 40 sets are presented to the raters.

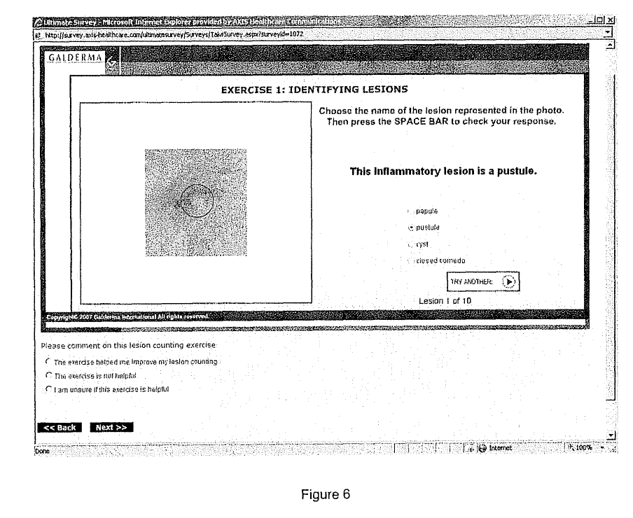

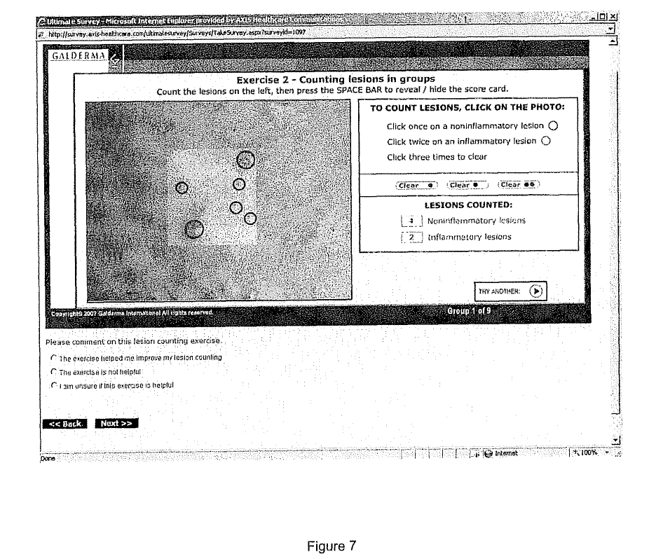

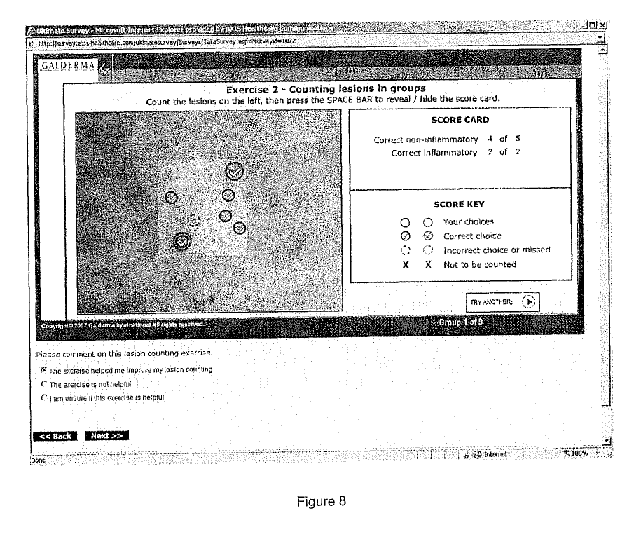

The second part of the online tool is lesion counting training. This part comprises lesion counting exercises and is divided according to difficulty levels or gradual steps. First level is dedicated to identifying acne lesions from other skin lesions (Exercise 1 and Example 1—FIG. 6). Second level is dedicated to identification of acne lesions according to non-inflammatory, inflammatory classification (Exercise 2 and Example 2—FIGS. 7 and 8).

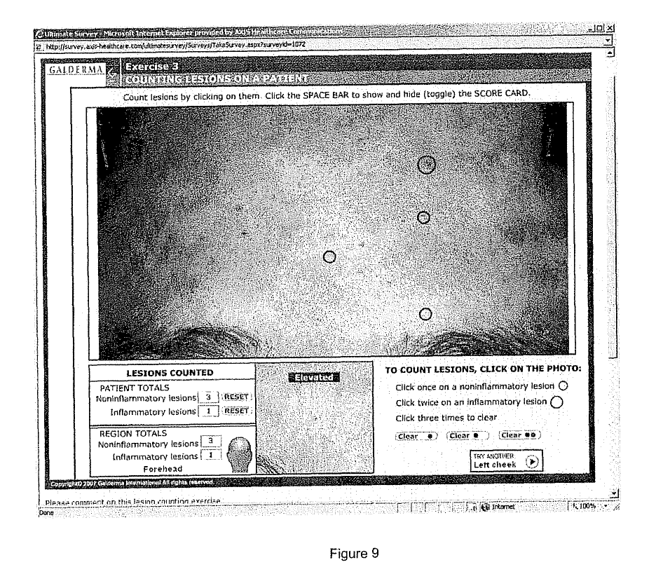

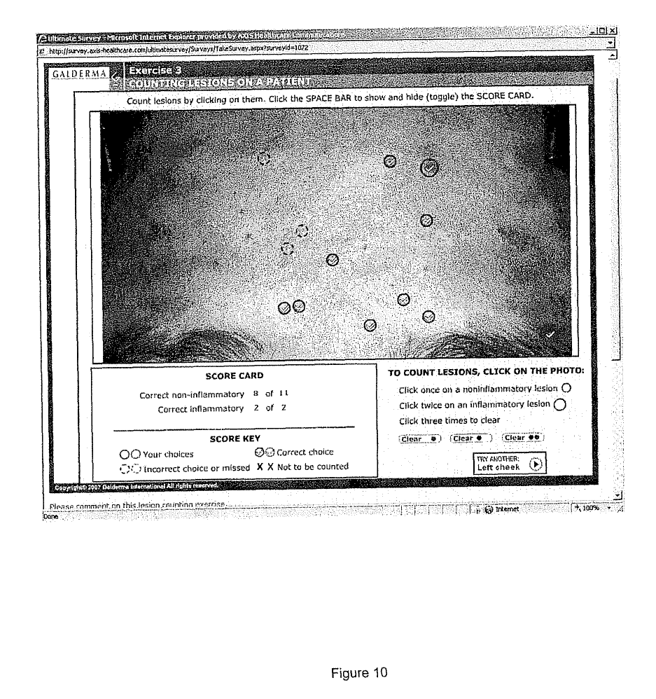

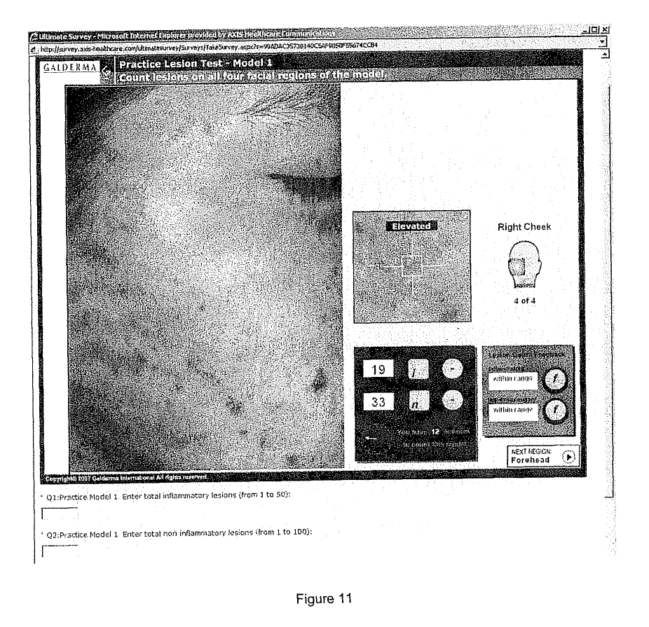

Third level provides training of acne lesions counting in 4 areas of the face according to non-inflammatory and inflammatory classifications (Exercise 3 and Example 3—FIGS. 9 and 10).

For the purpose of this invention, the lesion classifications were based on a consensus classification from 5 to 6 dermatologists or dermatology study coordinators to function as expert lesion count trainers. The trainers were selected based upon their knowledge and experience in lesion counting and in particular, were responsible to select photos of models with suitable acne for online training and testing.

For the consensus classification, online photos of acne models were assessed for specific counts of both inflammatory and non-inflammatory lesions.

The consensus range was defined as the highest and lowest expert trainer's count, as well as, the mean counts+/−30% for a given model (for example the mean is 100 the margin 70-130).

The mean was calculated for each model and a plus or minus 30% margin was applied around the mean count. Both the mean+/−30% to the range (highest and lowest expert count) was considered an acceptable range for raters to pass. Anything outside of these 2 criteria was considered a failure.

The range obtained from the testing models was used for the online testing activity.

All trial participants are encouraged to experience the web-based lesion count training, that is constantly available to users worldwide. This tool allows both new and experienced acne lesion counters to learn by reviewing an interactive textbook equivalent introduction into acne lesion types and progressing their knowledge in the interactive lesion count training session.

Before taking the first lesion counting exercise, an investigator is offered the opportunity to listen to a lesion count lecture electronically presented by an expert in dermatology research and describing the overview of the basics for lesion counting and the identification of inflammatory and non-inflammatory lesions.

Lesion count trainees begin with Exercise 1. This exercise uses photos of isolated lesions that most closely resemble the descriptions of each lesion included in the clinical study protocol as shown in FIG. 6. Trainees select the name of the lesion on the right that most closely matches the photo on the left.

Consensus from a group of acne experts was obtained on every lesion in this exercise.

The following are the definitions of lesion types that will be counted:

Inflammatory Lesions;

Papule—A small, red, solid elevation less than 1.0 cm in diameter;

Pustule—A small, circumscribed elevation of the skin that contains yellow-white exudate;

Noninflammatory Lesions;

Open comedone—A pigmented dilated pilosebaceous orifice (blackhead);

Closed comedone—A tiny white papule (whitehead);

Other Lesions;

Nodule—A circumscribed, elevated, solid lesion generally more than 1.0 cm in diameter with palpable depth;

Cyst—A smooth, dome-shaped, elevated, freely moveable, skin-colored, round to ovoid lesion greater than 0.7 cm in diameter.

This exercise ensures that everyone participating in the clinical study is identifying and describing lesions in a consistent manner. The majority of users rated this exercise as helpful.

### Lesion Count Training—Web Exercise 2:

Exercise 2 uses photos of isolated groups of lesions and provides users with a tool to label specific lesions on the photo as non-inflammatory or inflammatory as shown in FIG. 7.

This tool allows users to modify or reverse their decision, and it counts each lesion for them, displaying totals of each region and a total for the model on the left of the screen.

This tool also allows users to clear one or both types of lesions in order to practice again before trying another photo and provides feedback as well according to FIG. 8.

Feedback on incorrect choices guides users to the correct choices for each lesion before moving on. Scores are provided for the benefit of training, they are not stored or used for approval purposes.

This exercise ensures that everyone participating in a clinical trial is identifying and describing lesions in a more standardized manner. According to an online survey, the majority of users rated this exercise as helpful.

### Lesion Count Training—Web Exercise 3:

Exercise 3 uses four photos including forehead, left cheek, right cheek, and chin that when combined are representative of a model's entire face. The counting of the regions is similar to the systematic regional counting approach of a lesion counter evaluating the facial acne lesions of a patient enrolled in a clinical trial. Once again the program provides users with a tool to label specific lesions on the photo as non-inflammatory or inflammatory as shown in FIGS. 9 and 10. This exercise also provides a moving zoom and an “Elevated” label to compliment elevated lesions. This mimics the live model counting experience where lesion counters palpate lesions on a model's face in order to help qualify the lesions.

This tool allows users to modify or reverse their decision, and it counts each lesion for them, displaying totals of each region and a total for the model on the left of the screen.

This tool allow users to clear one or both types of lesions in order to practice again as well as providing feedback according to FIG. 10.

In addition to providing a lesion counting experience as close to the experience of counting lesions on a live model, this exercise helps users establish the habit of approaching each model with a consistent method. The exercise encourages users to begin counting on the model's right forehead and progress clockwise to cover the face. When lesion counters adopt the consistent lesion counting approach to each model, variability in lesion counting can be reduced.

The third part of the online tool is a live simulation of lesion counting (practice models—FIG. 10) as it will be required during clinical trial. Similarly, the last level of the second part of the tool includes sets of model photos that are presented to the dermatologist and/or study staff for an evaluation in a specific recorded amount of time. Failure to successfully pass this training may demonstrate that a dermatologist and/or study staff require further training. Again, the dermatologist and/or study staff may decide to practice training modules by repeating the exercises described above.

One of the advantages to the on-Line Lesion Count Training and Testing Tool is that it reduces the need for time spent training raters via live models during face-to-face investigator meetings.

For the purpose of this exercise, five practice models and 3 test models are available with consensus counts from 6 lesion count experts.

Again, a feedback mechanism is available for the practice model based on the consensus counts. Expert consensus provides a mean range and an actual range for both inflammatory and non-inflammatory lesion counts for each model. For each model's counts, the most extreme range values are coded in the practice test program. When a user clicks the f-button in the practice test feedback area, the program compares the user's count with the coded range values, and displays “too low”, “too high” or “within range” feedback.

Once the lesion counter completes the practice models, he/she may proceed to testing.

After completion of Test 1, the test page instructs the users not to take Test 2 until receiving invitation to do so.

If the lesion counter fails Test 1, the user is invited to proceed to Test 2. No additional link is needed to proceed to the next test.

If the lesion counter passes either the first or second attempt, the user is issued a certificate of approval.

For this testing, users count the forehead first, followed by left cheek, chin, and finally with the right cheek. The clockwise counting exercise can be repeated as many times as desired. Each model session is timed at 15 minutes by the program, which inserts a session time number on the user's computer in order to track session time. Using the keyboard i-key or clicking on the i-button, users can add to the total inflammatory lesions. The n-key is programmed in the same way to help count non-inflammatory lesions.

For the practice models only, users can gain feedback on the 4^{th} screen (right cheek) after completing lesion counting on the model. Feedback is either “too low”, “too high” or “within range”, exactly the same feedback that would be given in a training session involving live acne models.

When finished counting, the user copies their total inflammatory and non-inflammatory lesions into the fields below and submits to the system. Results are documented but not shared with the rater. When a rater passes a test, a certificate is issued to the rater.

In another embodiment, the present invention features a training method to enable dermatologists and/or study staff to recognize, identify and distinguish acne lesions among different types of known skin lesions. This method can be performed via an interactive online tool such as through use of a computer and/or the web.

The method comprises acquiring patients model images (e.g., photo views . . . ) to be assessed and approved by a group of experts; providing a plurality or “bank” of approved images and, specifically, populating a database with approved images (e.g., photographs, sketches, etc.) of general categories of isolated lesions and then using the populated database to train users (e.g., dermatologists and/or study staff, etc.) to identify lesion types when patients are subsequently examined. The image database may be a so-called “paper” collection of photographs of lesions, contained in photograph books, on flash cards or, preferably, the photographs will be accessible via an electronic database via one or more computer terminals. The computer terminals can be designated “stand-alone” terminals having wired or wireless communication with, and in close proximity to, a server interfaced with the image database as part of a training seminar. Alternatively, the computer terminals can be standard PC type devices remotely located from the database server and in communication therewith via the internet (web access) or any other computing device.

Based on the bank of approved “primary” images illustrating types of lesions, a “secondary” group of images is provided and categorized. This secondary group illustrates general lesion types and variations thereof. In one embodiment, the number of primary images is 180 and the number of secondary images is 60 and preferentially from 20 to 40 images. The grouping and classification is based on single lesions, groups of lesions and regions of a patient's skin, e.g., face, upper arm, lower torso, etc. In another embodiment, the grouping and classification also include a category for the entire face of the patient. Next, the lesions in each of the secondary image groups are qualified and quantified. In this manner, the database is created for use in training users, such as dermatologists and/or study staff to identify particular types of acne lesions. Feedback from survey questions collected from the training programs were used to capture input from training participants (e.g., dermatologists and/or study staff,) in an effort to further develop the protocol/tools. Once the dermatologist and/or study staff reached a desired minimum threshold level of distinguishing from categories and types of lesions, the dermatologist and/or study staff will be deemed to be qualified in screening patients for eligibility to participate in clinical trials of drugs.

In accordance with the method of the invention, an instructional interactive training program having multiple exercises is implemented using the primary and secondary groups of images in the database. As part of the training, certain exercises are performed as part of lesion count training. Here, the types of exercises that are performed ensure consistency among clinicians in lesion count and identification. In one embodiment, the training program exercises include navigation, interactivity, and feedback for determining whether the training is effective. The method of the invention also includes a component that is directed to facilitating program management and coordination.

The source of the images used in the database may vary. For example, the images my be imported into flash memory, where a trainee would then circle, point or otherwise designate subject lesions in images displayed on a computer terminal using a stylus, as is known in the art. In cases where the images are poor (unclear, not centered, etc.), it is possible to adjust the resolution or otherwise manipulate the image, such as by cropping or adjusting lighting. The images are also embedded with code such that an interactive training exercise can be achieved. The images are configured and loaded into a database, e.g., an ultimate survey, for use in training users to advance the ability to achieve more effective clinical trials due to classification of patients in a more standardized manner.

In a computing environment, a world-wide web home page is set up for enrolling users in the training sessions. Naturally, it will be appreciated that this will permit full user administration and permit technical support to be provided to the users.

In order to further illustrate the present invention and the advantages thereof, the following specific examples are given, it being understood that same are intended only as illustrative and in nowise limitative.

### EXAMPLES

### Example 1

### Exercise 1 of Web-Based Lesion Count Training

This exercise uses photos of isolated lesions that most closely resemble the descriptions of each lesion included in the clinical study protocol as shown in FIG. 6. Trainees select the name of the lesion on the right of the screen that most closely matches the photo on the left.

An immediate feedback on the selection is offered to trainees (by using Space Bar). Feedback on incorrect choices leads users to the correct the choice for each lesion before moving on. There are 10 isolated lesions in the current version of this exercise.

### Example 2

### Exercise 2 of Web-Based Lesion Count Training

This exercise uses photos of isolated groups of lesions and provides users with a tool to label specific lesions on the photo as non-inflammatory or inflammatory as shown in FIG. 7.

When users label a lesion using their mouse pointer, the tool allows them to modify or reverse their decision, and it counts each lesion for them, displaying totals on the right of the screen. Users can clear one or both types of lesions in order to practice again before trying another photo.

When users are satisfied with their assessment of the group of lesions, they can gain immediate feedback on their choices as shown in FIG. 8. Feedback on incorrect choices guides users to the correct choices for each lesion before moving on.

### Example 3

### Exercise 3 of Web-Based Lesion Count Training

This exercise uses four photos including forehead, left cheek, right cheek, and chin that when combined are representative of a model's entire face. The program activity provides users with a tool to label specific lesions on the photo as non-inflammatory or inflammatory as shown in FIGS. 9 and 10.

When users roll their mouse pointer over an elevated lesion, the mouse pointer icon changes from a small black circle (encouraging use for counting) to a human hand form with extended index finger. This exercise also provides a moving zoom that follows the user's mouse pointer with a close up of the photo and an “Elevated” label to complement elevated lesions. This mimics the live model counting experience where lesion counters palpate lesions on a model's face in order to help qualify the lesions.

When users label a lesion using their mouse pointer, the tool allows them to modify or reverse their decision, and it counts each lesion for them, displaying totals of each region and a total for the model on the left of the screen. Users can clear one or both types of lesions in order to practice again.

When users are satisfied with their assessment of each region of the face, they can gain immediate feedback on their choices as shown in FIG. 10. Feedback on incorrect choices guides users to the correct choices. Scores are provided for the benefit of training, they are not stored or used for certification purposes.

Each patent, patent application, publication, text and literature article/report cited or indicated herein is hereby expressly incorporated by reference in its entirety.

While the invention has been described in terms of various specific and preferred embodiments, the skilled artisan will appreciate that various modifications, substitutions, omissions, and changes may be made without departing from the spirit thereof. Accordingly, it is intended that the scope of the present invention be limited solely by the scope of the following claims, including equivalents thereof.

What is claimed is:

1. A web-based protocol/tool to improve the identification and characterization process of evaluators in recognizing and distinguishing acne lesions, comprising at least the following program activities:
a protocol for a global assessment of acne lesions;
a protocol for a lesion counting training;
a protocol for a model counting practice.

2. The web-based protocol/tool as defined by claim 1, divided in several program activities to train and test evaluators in identifying and categorizing acne lesions.

3. The web-based protocol/tool as defined by claim 1, which comprises program activities directed by software and encompassing models images approved by group of experts.

4. The web-based tool as defined by claim 1, comprising an interactive protocol/tool.

5. The web-based protocol/tool as defined by claim 1, wherein said global assessment comprises:
a learning session comprising several case models with lesion assessment rating
a testing session comprising cases showing at least 3 picture views of each model.

6. The web-based protocol/tool as defined by claim 1, wherein said global assessment comprises up to 60 model cases.

7. The web-based protocol/tool as defined by claim 1, wherein said lesion counting training comprises several sets of counting exercises.

8. The web-based protocol/tool as defined by claim 1, wherein said lesion counting training comprises at least 3 sets of exercises.

9. The web-base protocol/tool as defined by claim 1, comprising identifying, categorizing and counting acne lesions.

10. A method of identifying, categorizing and counting acne lesions, said method comprising the following steps:
acquiring model images to be approved by a group of experts
providing a “bank” or database of approved images and related expert consensus ratings
employing the database to train users to identify lesions and/or
employing the database to practice users to identify and count lesions when patients are subsequently examined.

11. A method as defined by claim 10, wherein the steps are performed with computer-based or web-based activities.

12. A method of identifying, categorizing and counting acne lesions, said method comprising employing the web-based protocol/tool as defined by claim 1.
